(19) United States
(12) Patent Application Publication
(10) Pub. No.: US 2005/0180387 A1
(43) Pub. Date: Aug. 18, 2005

(54) Method for organising communication between manager objects and managed objects in a communication network, architecture and software thereof

(76) Inventor: Maurizio Ghirardi, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/511,188

(22) PCT Filed: Apr. 8, 2003
(86) PCT No.: PCT/EP03/03625

(30) Foreign Application Priority Data
Apr. 12, 2002 (IT) TO2002 A 000 325

(51) Int. Cl. H04L 12/28

(52) U.S. Cl. 370/351

(57) ABSTRACT

A method for managing at least one managed object (B1, . . . , BN) through a communication network (R) by at least one manager object, comprising the following operations:—providing at least one intermediate object or hierarchic agent (AG) configured to manage said at least one managed object (B1, . . . , BN) according to a data set (1100), said management being translated into a set of results (1104),—providing said data set (1100) from said at least one manager object (A) to said intermediate object (AG),—managing said at least one managed object (B1, . . . , BN) through said at least one intermediate object (AG), to generate said set of results (1104), and—transferring (1108) said set of results (1104) from said at least one intermediate object (AG) to said at least one manager object (A). Preferably, communication between manager object (A) and intermediate object (AG) implements UDP protocol and compressed mode.

### TECHNICAL FIELD

This invention refers to the methods for establishing a communication between at least one manager object (hereinafter called “manager” in brief) and at least one managed object (hereinafter called “agent” in brief) in the context of a telecommunication network.

### BACKGROUND ART

A typical reference architecture used for this purpose is shown in FIG. 1 illustrating the connection between a manager module A and a certain number of agent elements B1, B2, B3, . . . interconnected by a telecommunication network R.

This architecture, for example, is described in SNMP (Simple Network Management Protocol) specifications. Reference can be made to document RFC1157, revision 1990.

On a general level, Internet protocol architecture implements four logic levels, commonly called Application (A), Transport (T), Network (N) and Link (L).

As shown in FIG. 2, each level is in fact nested within the protocols underneath. For example, Application level protocols, such as the previously mentioned SNMP and TFTP, i.e. Telnet or FTP protocols, are nested within the protocols underneath.

Specifically, SNMP and TFTP protocols are nested in UDP (User Datagram Protocol), which in turn is nested in IP (Internet Protocol), and consequently injected in the physical carrier (cable, fibre, radio waves), indicated by reference D, by software drivers or hardware devices, to implement the Link L on a physical level.

Similarly, Telnet and TFTP protocols are nested in TCP (Transmission Control Protocol) which in turn is nested in the IP protocol and consequently injected in the physical carrier device L.

The main characteristics of TCP and UDP on the transport level can be described in the following terms.

TCP is a system communication oriented protocol (systems are identified by a network address) and it is linked to the software it employs. A connection, i.e. a permanent communication with the remote system, must be established before establishing a communication using this protocol. Data transfer is controlled and guaranteed but slow, especially when discontinuous or small. The delay is caused by the characteristics of the IP protocol and by the fact the connection is created after each request and removed, i.e. shut down, at the end of the communication if it is not used. The communication is costly in terms of employed system resources due to the complexity of the protocol and the checks to which data and connection are subjected to ensure correctness of the communication.

Conversely, the UDP protocol is process communication oriented and process communications are identified by logical ports each characterised by a number in the range from 0 to 65535. For transmission, the protocol accepts messages from various application procedures and passes them to IP protocols for transmission. This function is called multiplexing. For reception, the UDP protocol receives data packages from the IP layer via a destination application process. This function is called de-multiplexing.

The UDP protocol is much lighter in terms of resource utilisation and is simple to implement and manage. Specifically, it employs a brief sixty-four bit header (called “PDU User Header”) divided into “source port”, “destination port”, “length” and “check sum” and a ninety-two bit header containing the “source address”, “destination address”, “filler”, “protocol type”, “length PDU” fields.

The UDP protocol is fast because the IP transmission protocol does not require processing or checks; it simply transmits, where possible, from the current network address to the destination network address.

The native UDP protocol does not employ reception acknowledgement messages, does not sort messages, does not check flow and consequently is not completely safe or reliable because messages may be lost, rejected, duplicated, received in the wrong sequence or the arrival rate may be higher than that of the application and receiving process in the network.

A generic process architecture employing UDP as transmission protocol is characterised by being associated to a port according to criteria schematically illustrated in FIG. 3.

Two basic criteria are used to assign numbers to the reception and transmission ports.

A first criterion consists in defining universal assignments in which the respective numbers are official defined and recognised by all parties.

A second criterion consists in defining dynamic binding according to which a program asks for a port whenever needed and the port is assigned by the network software. Reception ports are normally pre-assigned even if they may be modified. Transmission ports may be defined by using either of the two methods.

Specifically, in the diagram shown in FIG. 3, reference PA generically indicates the various application processes (1, 2, 3 . . . ) which interface with the UDP protocol via three respective ports.

Additional integrative components called “physical objects” and “logical objects” can be identified, in addition to application process in UDP protocol based management architectures, as shown in greater detail in the diagram shown in FIG. 4.

Application processes can be additionally split into originator application processes with manager function, generically indicated by reference A and one (or more) destination application processes (called agents) according to the role performed at the time.

The term “physical object” is used for hardware containers or media (e.g. a personal computer) which host other physical objects needed for application operation. The containers are identified in the diagram shown in FIG. 4 by references P₁ and P₂. Additional physical objects include the physical (e.g. a RAM) and/or virtual (e.g. file) processing memory and the central processing unit (CPU) employed by the hardware medium or media for running the processes (software, basic firmware, protocols, applications). Memories of this sort are shown in the diagram in FIG. 4 by references R₁ and R₂.

In the diagram shown in FIG. 4, reference W indicates the system software on operating system level and references Y and Z indicate the software consisting of one or more application software oriented protocols (transport) and the network board or CR transducer oriented software (in this case consisting of one or more protocols) for interfacing with the network R.

The following description refers to the diagram in FIG. 4, which shows the relations between application processes, objects and architectural components. A system software W is used to perform the assigned tasks in a system or device employing an available portion of the processing memory R₁, R₂.

A process A residing in system P₁ interfaces with a process B residing in system P₂, through components W, Y and Z necessarily present in both devices, network boards and physical medium.

The software components A, B, Y, Z and W use and share a certain amount of memory R₁, R₂ according to their characteristics.

The maximum usable band is linked to the characteristics of the network R and of the network boards CR, which must necessarily coincide.

The possibility of using an architecture of the type shown in FIG. 1 is conditioned by a number of factors.

Firstly, the maximum usable band of the network R is conditioned by the number of managers and agents and the amount of generated traffic. The usable band may be maximum only when there are only two devices, i.e. one manager and one agent. The usable band must be shared if there is one manager and several agents. Consequently, the maximum usable band for each communication between manager and agent cannot be guaranteed.

Generally, the communication between a manager and several agents can be managed either by means of a sequential strategy or a parallel strategy.

In the sequential strategy, the manager establishes a communication with an agent and waits for the communication to end before continuing with the next communications.

The parallel strategy exploits the multiplexing and de-multiplexing functions offered by the protocol (which is typically a UDP, User Datagram Protocol) through a competitive dynamic port assignment mechanism to establish a certain number of simultaneous communications with several agents.

According to the sequential method, both the manager-to-agent output band (i.e. the sum of total transmitted message sizes divided by the time employed to send them) and the manager input band (i.e. the sum of the total message sizes received by each node manager divided by the time required by the manager to receive them, the reception time being the sum of the agent processing time plus the network delay) are low, because transmission and reception times are long.

According to the parallel method, the manager-to-agent output band is high and the input band may be very high, because transmission and reception times are very short and because the replies are certainly greater than required.

The architecture according to the known art shown in FIG. 1 presents many limitations and shortcomings.

Sequence transmission is not effective when the number of agents exceeds a certain value (e.g. one thousand). This is because the time required to complete activities considerably increases. Furthermore, the architecture in FIG. 1 generates traffic bursts, also of large dimensions, due to the fact that the traffic generated by the simultaneous requests by managers and the return traffic generated by the agents may occur at the same time. This may exceed the available band limits with consequently degraded network functionality and loss of messages.

The parallel method employs several manager processes assigned to different UDP ports and this may use up all system resources, such as RAM and CPU.

The protocols used by application process, e.g. the aforesaid SNMP protocol or the TFTP Trivia File Transfer Protocol (see document RFC1350), are not optimised for transporting large amounts of information or for working in networks with a high number of protocols. Additionally, the protocols are of the point-to-point type and consequently multilevel architectures cannot be implemented and managed.

Furthermore, as shown in the architecture illustrated in FIG. 1, all agents should in some way be directly reachable by the manager. The agents which cannot be directly reached by the manager, e.g. because they are connected to different networks from the manager, require the installation of a dedicated manger in order to be managed.

### DISCLOSURE OF THE INVENTION

The object of the invention is to provide a solution capable of overcoming the aforesaid shortcomings.

According to the invention, this object is obtained by a method whose characteristics are specifically recited in the annexed claims. The invention also relates to the corresponding network architecture and the corresponding software, i.e. the software which can be directly uploaded to the memory of a digital processing unit comprising software code portions capable of implementing the method according to the invention when the software is run by at least one digital processing unit.

Essentially, the solution according to the invention implements an optimised multilevel management architecture to subdivide management activities over several machines whereby overcoming the limitation related to the need of utilising a traditional single level architecture. All this limits the use of the band, specifically as concerns the possibility of optimising utilisation of physical manager resources.

Briefly, the solution according to the invention consists in realising an intermediate object, i.e. a new type of agent, called “hierarchic agent” capable of receiving sufficient information from the manager to perform the management activities that the manager would perform directly on the controlled agents.

Consequently, as better described in the description that follows, the solution according to the invention is suitable and particularly advantageous when used in combination with compressed UDP message transfer methods.

### Brief Description of Drawings

The invention will now be described, by way of example only, with reference to the accompanying drawings wherein:

FIGS. 1 to 4 refer to the known art and have been described above,

FIG. 5 illustrates the new management architecture according to the invention in general terms,

FIG. 6 illustrates a first form of embodiment of the solution according to the invention,

FIG. 7 illustrates a second form of embodiment of the solution according to the invention,

FIG. 8 shows an operative logic example of an architecture according to the invention,

FIG. 9 illustrates a possible communication management diagram within an architecture according to the invention,

FIG. 10 illustrates the shared agent management method,

FIG. 11 illustrates the architecture of a so-called hierarchic agent according to the invention,

FIG. 12 illustrates a possible organisation of the structure and nesting of controls supported by a hierarchic agent within the scope of the invention,

FIGS. 13 to 15, each split into two parts referred to transmission (part a) and to reception (part b), illustrate some preferred forms of embodiment of the solution according to the invention in the form of flow charts,

FIG. 16 is an additional flow chart illustrating the more general characteristics of the solution according to the invention, and

FIGS. 17 and 18 illustrate additional possible embodiments of the solution according to two possible variants of the invention.

### BEST MODE FOR CARRYING OUT THE INVENTION

The diagram in FIG. 5 shows the general architecture according to the invention.

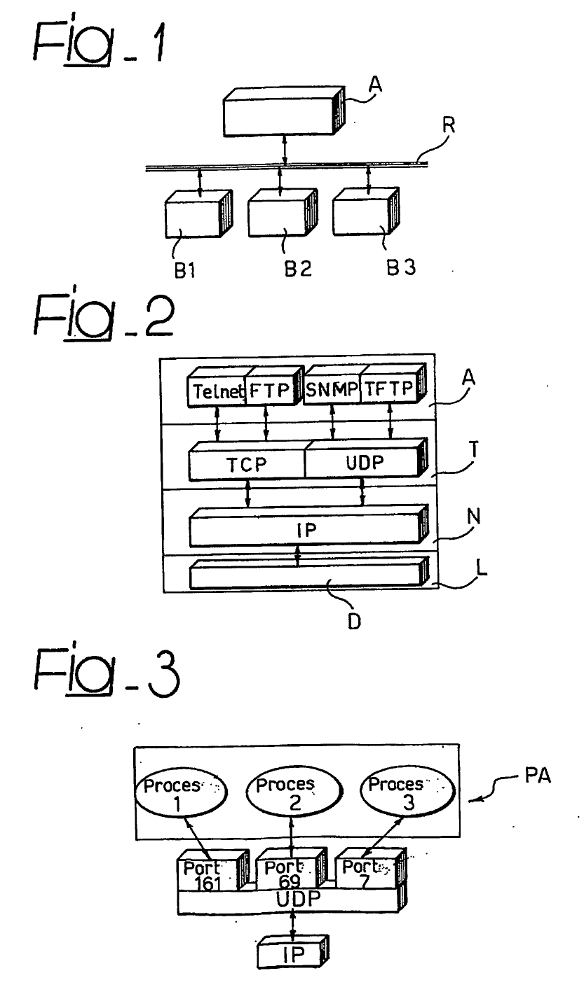

By direct comparison with the diagram in FIG. 1, an additional module, i.e. an intermediate object called hierarchic agent AG, is integrated in the architecture according to the invention based on the presence of a manager A and a plurality of agents B1, B2, B3 which reciprocally interface.

Essentially, the hierarchic agent AG interfaces with the manager A so as to receive a sufficient amount of information from the manager A to carry out the same management activities of manager A on a certain number of agents B1, B2, B3 (any number of agents is possible).

In the solution according to the invention, manager A may continue to preserve and directly control other agents, indicated by references Bk, . . . , BN in the diagram in FIG. 5.

Obviously, any number of the number of agents B1, . . . , BN and any number of divisions for management purposes between hierarchic agent AG and manager A can be implemented.

The architecture schematically shown in FIG. 5 is used to create multilevel architectures without duplicating manager functions because a new element (i.e. the hierarchic agent AG) may be used to carry out the necessary activities and obtain the required results.

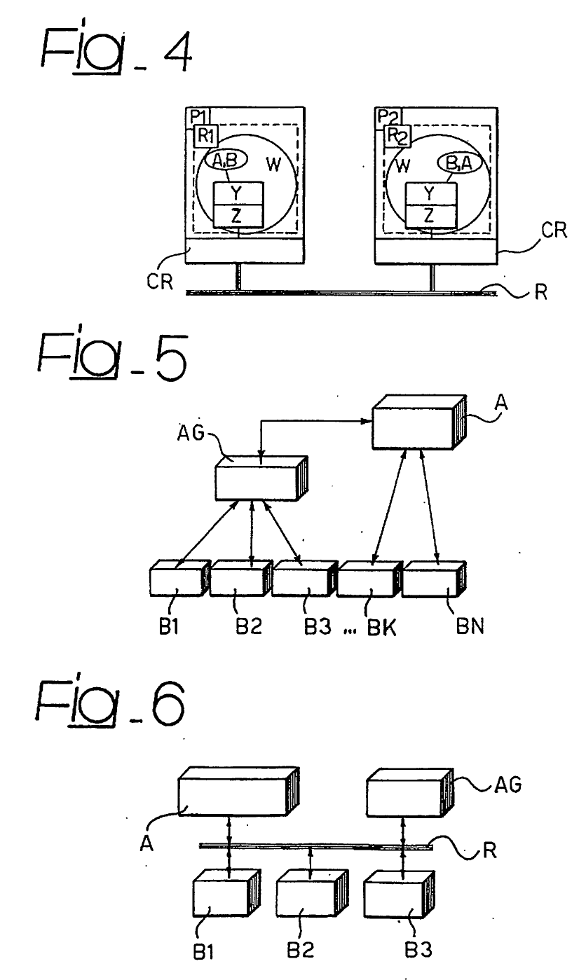

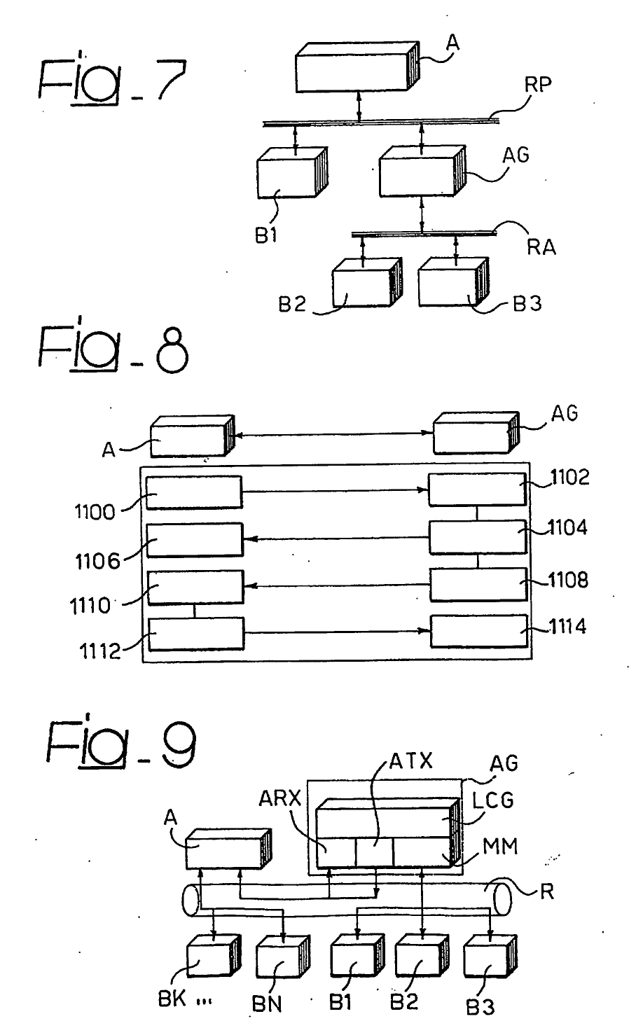

In practice, the intermediate objects called hierarchic agent AG is capable of receiving suitable formatted messages from manager A by being presented as an agent (B1, B2, B3, . . . ), e.g. SNMP messages containing sufficient information to perform the activities required by the manager A on specific agents identified by means of a network address using specific protocols (SNMP, TFTP, Telnet, DNS, etc.). After the required activities, the AG module sends the results to the manager A. The interconnection between manager A and hierarchic agent AG may be implemented using the network R (as in the form of embodiment shown in FIG. 6) or using different networks via a double connection (as the form of embodiment shown in FIG. 7, where references RP and RA indicate the two networks).

The diagram in FIG. 7 shows the extreme flexibility of the solution according to the invention.

Specifically, the diagram shows that the first network, indicated by reference RP, may be used for communications between manager A and an agent B1 which continues to be managed directly by the A, for allowing communications between manager A and hierarchic agent AG which “replaces” the manager A in the management of the agents B2 and B3 in a second network indicated by reference RA.

The solution according to the invention also optimises use of the network (or of the networks, in general) in terms of band.

Specifically, algorithmic compression is preferably applied on the data contained in the application protocols (OID in SNMP, payload in UDP, etc.) to reduce network traffic due to communication between manager A and hierarchic agent AG.

This method essentially consists in subjecting (at least) the message payload to a compression operation preferably based on acknowledgement of sequences which periodically appear in the message. In a specifically preferred way, this compression operation is carried out according to a gzip method, such as zLib.

This method, which will be seen in greater detail with reference to FIG. 12 and following, reduces the number of exchanged PDU data packages in favour of higher data contents.

For example a data PDU in the TFTP protocol uses 516 bytes and consequently 1016 packages are required to transfer a 520 Kb file. Following compression according to the aforesaid criteria, 520 Kb is reduced to 4 Kb, which means that they can be carried in a single UDP data package or SNMP message. Transfer consequently consists in transporting “equivalent application messages” instead of “single messages”. This means that the quantity of generated traffic can be reduced, transferred data being equal.

The illustrated solution can also be used to optimise system resources needed to perform the activity.

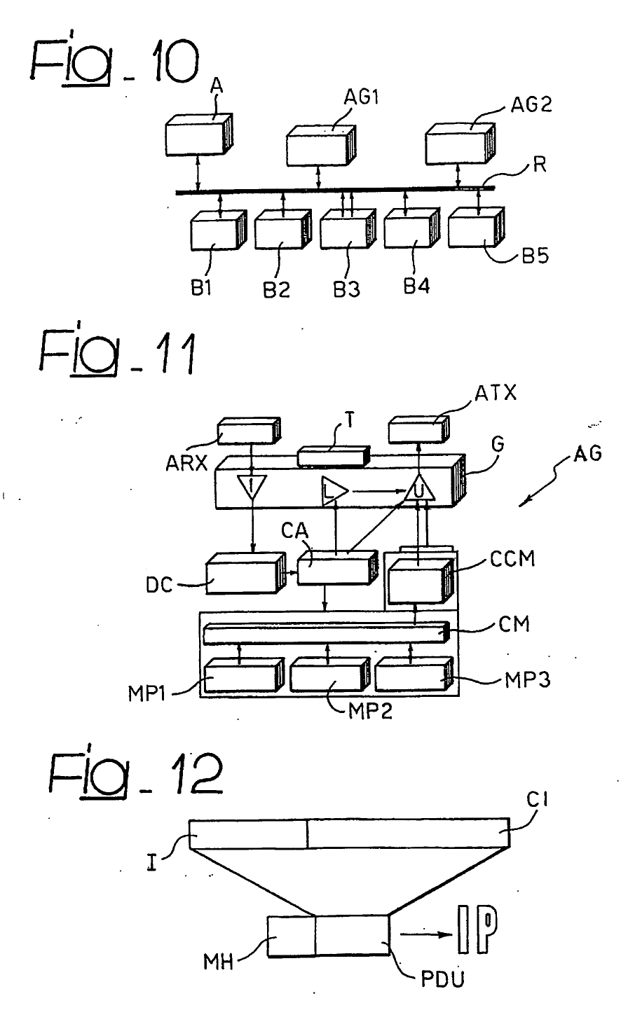

This is because the illustrated solution distributes the manager's activities over several hierarchic agents AG, according to the criteria shown in FIG. 10, for example. In this figure, references AG1 and AG2 indicate two hierarchic agents which co-operate with a manager A to manage a certain number of agents B1 to B5, the management of one or more agents (agent B3, in the example shown) being shared by two hierarchic agents AG1 and AG2.

The possibility of sharing the activities of manager A over several hierarchic agents may be exploited to use the resources (CPU, RAM, etc.) which are free at the time. Return traffic to the manager A—generated only at the end of the activities—exclusively by hierarchic agents AG1 and AG2 consists in the results transferred by the hierarchic agents AG1 and AG2 to the manager A. This occurs preferably according to the compressed method, consequently by employing a few packages whose size is medium-to-small and whose data contents is high. These packages do not affect system resources of the manager A needed for decompression and management.

In this way, as shown in the diagram in FIG. 8, the interaction between manager A and hierarchic agent AG (reference will be made to a single module on this type in the text that follows for the sake of simplicity and extension to several hierarchic agent modules will be obviously understood) is based on performance of micro-activities and exchange of signals useful for management.

Specifically, in the step indicated by reference 1100, manager A sends an activity request to hierarchic agent AG in the form of messages, e.g. by using a standard or compressed SNMP message. In the step indicated by reference 1102, the hierarchic agent AG receives and analyses the request, starts processing and collecting information. During processing—step 1104—hierarchic agent AG sends statistic messages and messages for synchronising the status of activities in progress to the manager: this occurs in the step indicated by reference 1106. Having ended the management activities of the managed objects, i.e. the agents, the hierarchic agent AG sends the results to the manager A. This occurs in the step indicated by reference 1108. In the step indicated by reference 1110, the manager A receives and processes the results of the activity by sending a result reception acknowledgement message to the hierarchic agent in step 1112. The hierarchic agent AG then ends the required activities in a step indicated by reference 1114.

This cycle may be repeated several times by the manager according to the obtained result. For example, new requests may be sent if some data are considered not sufficient.

The diagram in FIG. 9 describes the high level logical elements of the hierarchic agent AG and the relations with other components of the architecture.

It will be noted that the diagram in FIG. 9 essentially corresponds to the architecture in FIG. 5, in which manager A directly manages some agents Bk, . . . , BN, and delegates the management of other agents B1, B2 and B3 to hierarchic agent AG. The interfacing of the network R is shown in FIG. 6.

The manager A interfaces with its direct agents and with the hierarchic agent AG through communication implementing UDP protocol, e.g. using standard or (preferably) compressed SNMP messages.

For this purpose, in addition to the control and management logic LCG, the hierarchic agent includes two modules (indicated by references ARX and ATX, respectively) for managing communications between the hierarchic agent AG and the manager A so that the hierarchic agent AG may be “seen” by the manager A essentially as if it were another agent managed directly by the manager A.

The hierarchic agent AG additionally comprises a multi-manager module MM which superintends communications between the hierarchic agent AG and the agents B1, B2, B3, so that each agent may essentially “see” the hierarchic agent AG as if it were the manager A.

The manager A and the multi-manager component of the hierarchic agent AG communicate with the various agents using standard methods/protocols.

Consequently, as shown in the diagram in FIG. 10, one agent (agent B3 in the example shown) may be managed by one or more hierarchic agents AG1 or AG2 controlled by the same manager.

The diagram in FIG. 11 illustrates the internal architecture of the hierarchic agent AG for implementing the result management and control logic.

In a preferred way, the solution according to the invention is based on complete message compression (header, indicated by references MH, and PDU).

Specifically, two possible different transfer methods or embodiments are employed. The first nests the SNMP message in a new compressed SNMP message and sends it using standard UDP. The second controls the UDP directly via a driver providing the result of the SNMP message compression as Data Octet.

The compression method is essentially based on the acknowledgement of sequences which appear periodically in the message.

In a particularly preferred form of embodiment, a variant of the method known as LZ77 is employed as compression method (see Ziv. J., Lempel A., “A Universal Algorithm for Sequential Data Compression”, IEEE Transactions on Information Theory, Vol. 23, No. 3, p. 337-343); the method is well known in UNIX environment. It is called gzip (gzip format—RFC 1952) and used also by the popular PKZIP application. The specifications of this method are of public domain. Source libraries are available for implementing and using these solutions in various development environments and operating systems, such as HP-UX, Digital, BeOS, Linux, OS/2, Java, Win32, WinCE.

Specifically, algorithm porting can be used on win32 using the “zLib” library. The main characteristic of the library is to allow runtime and on-memory compression of both binary data structures and strings, which is a fundamental factor in system performance.

The diagram in FIG. 11 shows the ARX modules and ATX mentioned above with reference to FIG. 9.

The ARX module is exclusively responsible for collecting the messages from the network R passing them to an input queue I included in a queue management module indicated by reference G.

Symmetrically, the ATX module is exclusively responsible for sending the messages from the output queue of the queue manager G indicated by reference U.

Queues manager or Module G is exclusively responsible for analysing the messages from the input queue I, the output queue U and another queue (called working queue) indicated by reference L at each clock pulse.

Said clock signal is generated by a timer module or timer indicated by reference T, which is exclusively responsible for generating the synchronisation clock of the queues manager G.

The messages in the input queue I are taken and sent to a DC module, which is an interpreting module (and decompression module, in a preferred embodiment) of the messages, for future processing at each clock signal generated by the timer T. Said decompressing/interpreting module is indicated by reference DC.

Furthermore, the messages in the working queue L are analysed at each clock signal generated by the timer T; a message indicating activity status in the output queue U are generated for each message in the queue.

At each clock signal from the timer T, the messages in the output queue U are transmitted to the manager through the ATX module.

In greater detail, the DC module is exclusively responsible for analysing each message received by the input queue I, decompressing it if required and sending it according to priority to an activity co-ordinating module CA indicating the method and type of activity to the performed.

The CA module essentially is responsible for:
instanctiating a concurrent process suitable to the request of the message interpreter by co-ordinating activities through a manager controlling module, indicated by CM, and monitoring the status;
updating activity status of the requests in the working queue L, and
creating statistic check messages to be sent to manager A through the output queue U, these messages containing statistic information on the overall operation status of the instancing concurrent processes.

The CM module is responsible for managing both in a co-ordinated and separate way possible other protocol manager modules (of which three are shown herein by the way of example, indicated by references MP1, MP2, MP3) by collecting and analysing the received information. At the end of the activity, the result is sent to a message compiling and compressing module, indicated by reference CCM, in view of the subsequent insertion in the output queue U for subsequent transmission to the manager A.

The CCM module is exclusively responsible for managing the result of the activities generated by the concurrent process, creating the message and possibly compressing it if the request was compressed, placing it in the queue manager output queue.

Each of the modules called protocol managers MP1, MP2, MP3 (as mentioned there can be any number of managers according to the number of protocols to be managed) is responsible for communicating with agents through a specific respective protocol (e.g. Telnet, SNMP, TFTP, etc.).

Within the system, a univocal identification number is assigned to each message for rapid, error-free identification in the architecture. The characteristics of the hierarchic agent AG agent architecture can be outlined as follows.

The hierarchic agent AG is configured as a lighter module with respect to a traditional manager because simple components are used to emulated network protocols (e.g. SNMP, Telnet, DNS, TFTP, etc.). For example, in the case of the TFTP protocol, only the basic units which make communication with agents compliant with the protocol are implemented instead of the entire server.

The hierarchic agent AG is also faster than a traditional manager because it uses and optimises only the RAM of the host system without accessing disks or databases, for example, which is notoriously slower. Additionally, the hierarchic agent AG does not contain complex manager type message processing functions and is consequently more effective with respect to a traditional manager in terms of resource use being activated only be reception of a request from manager A and deactivated at the end of the activity.

The described architecture is used to implement several simultaneous, co-ordinated activities which involve several protocol typologies, providing the possibility of accessing the agents in hierarchic mode, i.e. allowing that a certain agent may be reached by two hierarchic agents, the first of which acts as a primary element and the second which acts as a secondary element to the manager A.

This means that the secondary hierarchic agent can be used when the first is not available.

The described solution is consequently more robust in the event of failures or, in general, (also temporary) unavailability of certain elements.

The availability of ARX and ATX modules for disjoined two-way communication means that high volumes of input traffic can be managed without compromising transmission performance. Particularly, ATX module transmission is managed according to a method which may be called either “timed” or “gaussian” for blocks of messages according to the respective priorities. This approach avoids possible bursts of traffic because a predetermined number of messages is sent at each clock signal according to priority (e.g. twenty priority “1” messages, ten priority “2” messages, eight priority “3” messages, two priority “4” message and one priority “5” messages), while the remaining messages are queued and sent during the next cycle. Additionally, this prevents the formation of “bottlenecks” because each message flows from one module to the other through internal buffers which disjoin the module processing speeds.

In a particularly preferred embodiment, the structure of the messages used for communication between manager A and hierarchic agent AG, according to the method illustrated in FIG. 12, presents a header I followed by a data body CI.

In this specific case, the header I typically contains the following information:
message format version (e.g. 1.0),
maximum command processing time (in milliseconds),
compressed contents indicator (1=encoded, 0=non-encoded),
error description (compiled in messages confirming the absence of errors or containing the text of the error),
message size in bytes,
IP address of the agent on which to perform the activity,
priority of the message indicated by the manager (0=priority assigned by the hierarchic agent AG, 1=maximum, 5=minimum),
identification of the manager of protocol to be used,
required activity typology (the command itself),
source UDP port of manager request,
version of manager A or hierarchic agent AG,
univocal identification of request within manager.

The data body CI contains specific information for the protocol manager (MP1, MP2, MP3, . . . ) to be used to perform the required activities. These indications differentiate according to the activities to be performed and the protocol used. The following contents may be expressed, for example, as follows:
SNMP procedure: contains a standard SNMP message with OID SNMP to be requested, typology of operation to be performed (GET, GET NEXT, SET and BULK, etc.),
Telnet procedure: contains authentication parameters (UID, password), operator command, indication whether to return outputs generated by commands,
SNMP procedure: contains OID SNMP of all MIB branches to be collected through the standard SNMP operation typology (BULK or GET NEXT),
co-ordination procedure: contains multi-protocol coordination method in form of script,
TFTP file management procedure (non standard): contains activity typology (upload or download), list of files to be collected or downloaded,
agent reachability test procedure: contains test typology/typologies to be performed via DNS look-up and reverse DNS look-up, ping, Telnet and SNMP port reachability,
hierarchic agent reachability test procedure: does not contain activities to be performed and is used by manager A to test reachability of the hierarchic agent AG, and
statistic transmission command: contains data for registering and defining the UDP port of manager A to which statistic data must be sent.

Commands in turn may be compressed and nested using an algorithmic compression method consisting of a compression operation, specifically based on acknowledgement of sequences which appear periodically in the message.

Specifically, as shown in the diagram in FIG. 12, the header I and the data body CI of the message may be nested in a message structure supported by the hierarchic agent AG comprising a message header MH and the remaining part PDU to generate a SNMP or UDP message susceptible of transiting on IP level.

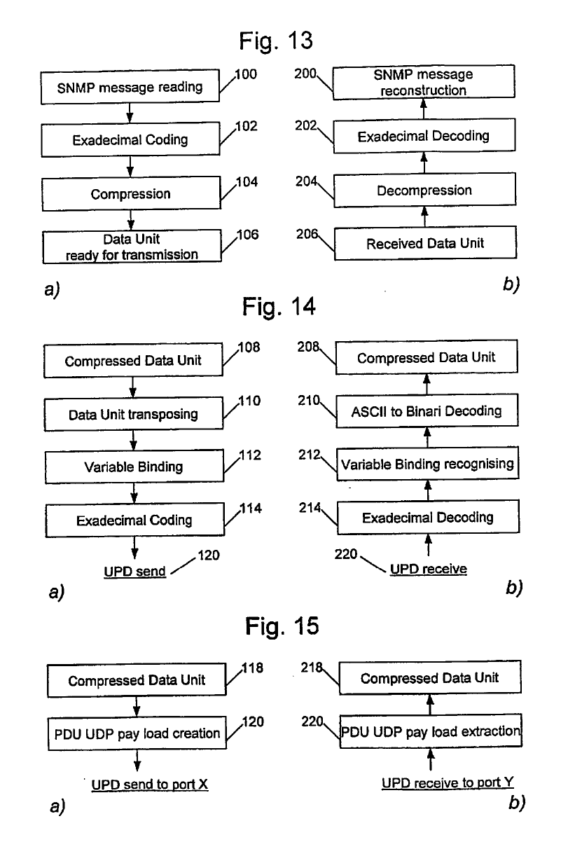

The flow charts in FIG. 13 illustrate the method used for compressing (FIG. 13a) and decompressing (FIG. 13b) the SNMP message.

The flow charts in FIG. 14 shown (again with reference to FIG. 14a for transmission and to 14b for reception) a first solution in which a compressed SNMP message is transferred via SNMP nesting.

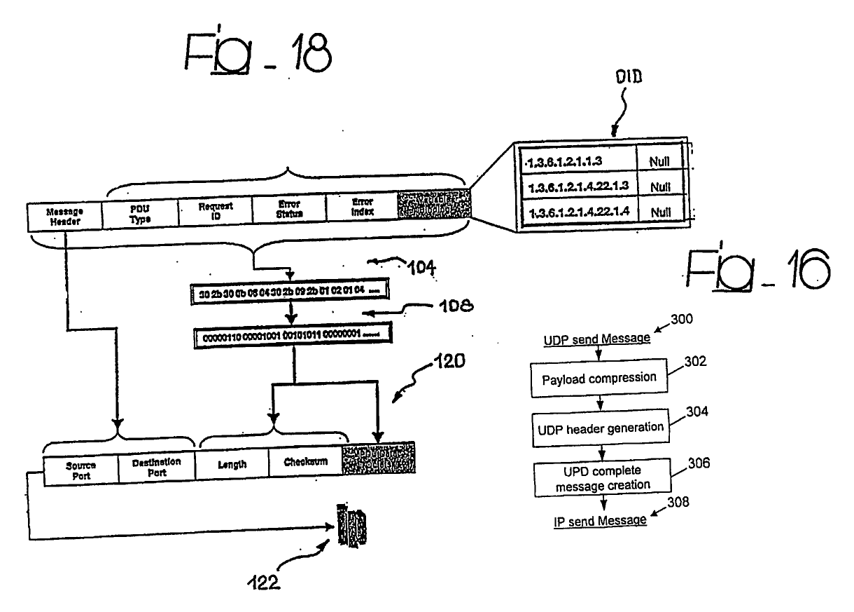

The flow charts in FIG. 15 refer to a transfer solution via UDP nesting. Separate reference is again made to transmission (FIG. 15a) and to reception (FIG. 15b).

The diagrams in FIGS. 17 and 18 refer to the total compression and transmission operations exemplified in part of a) of FIGS. 13 and 14 (FIG. 17) and part a) FIGS. 13 and 15 (FIG. 18), respectively.

In the flow chart in FIG. 13, reference 100 indicates the step in which the entire SNMP message (header+PDU) is read and converted, in a subsequent step indicated by reference 102 into hexadecimal format. This occurs by applying BER type encode.

The message encoded in this way is compressed on-memory using a compression method based on the acknowledgement of a recurrent sequence, such as the method documented in the previous mentioned zLib library.

This occurs in a step indicated by reference 104 to obtain a compressed data unit which is ready for transmission in step 106.

Symmetrically, the flow chart in part b of FIG. 13 comprises four steps 206, 204, 202 and 200 (intended to be processed in the order shown), in which the received compressed data unit (step 206) is subjected to decompression (step 204) in view of subsequent hexadecimal decoding (step 202) with subsequent reconstruction of the internal SNMP message (step 200).

The numeral references of the steps in the flow chart in part b) of FIG. 13 are reversed with respect to the processing order simply to highlight the symmetry with steps from 100 to 106 of the compression procedure. Similar choices are made with reference to the flow charts in FIG. 14 and FIG. 15.

As indicated, FIG. 14 and FIG. 17 refer to a transfer solution in which a compressed data unit is nested in a standard SNMP message characterised by a variable binding and standard UDP transmission method.

The compressed data unit nesting method in step 106 consists of an initial step (indicated by reference 108) in which the compressed data unit is read in bytes and then transposed (in a subsequent encoding step indicated by reference 110) into the corresponding set of ASCII characters.

The variable binding of the message consists of a first numbered OID (e.g. 1.3.6.1.4.666.1) which contains the value of the _ZIP_xxxx string (where xxxx is the size of the original file) and is generated in the subsequent step, indicated by reference 112 (possibly after auxiliary functions such as ACK TAB+NULL—see block 110a in FIG. 17). Proprietor code 666.1, which is currently not registered by IANA Internet Assigned Numbers Authority, has been used in the example above.

The subsequent variable binding elements which contain the compressed data unit translated into ASCII consist of OID/value pairs. The value contains portions of the compressed data unit transposed into ASCII format whose maximum size is 255 characters.

The header data of the SNMP message are then reconstructed. This occurs in step 112, which is followed by step 114 in which additional encoding according to BER method is performed to generate the PDU UDP payload intended to be used for sending data (step 116).

Also in this case, the steps indicated by references 216, 214, 212, 210 and 208 in part b) of FIG. 14, intended to be processed in the order in which they were shown above, are dual functions intended to be implemented during reception of steps from 108 to 116 referred to transmission.

By adopting the solution illustrated in FIGS. 14 and 17, the compressed SNMP message has a standard SNMP logic format and a proprietor content. Functional extension (minimal) is consequently required by the agent's manager to permit acknowledgement and encoding/decoding.

Experiments conducted by the Applicant demonstrate that this solution is entirely feasible without negatively affecting network architecture.

The alternative solution (to which reference is made in FIGS. 15 and 18) consists in preparing the compressed data unit starting from the SNMP message according to the method illustrated in FIG. 13 followed by direct nesting of said data unit in the PDU UDP payload.

Naturally, to ensure correct operation, this solution requires availability of a dedicated transmitter and receiver (e.g. such as the ARX and ATX modules in FIGS. 9 and 11), for example in conditions requiring the availability of a different UDP port than standard. The transmitter must consequently know which UDP port is used by the receiver and vice versa. Information on used ports can be exchanged on higher level by means of a synchronising message in standard SNMP format according to the criteria which are described in greater detail below.

By adopting the alternative solution illustrated in FIGS. 15 and 18, the compressed data unit made available during step 108 and intended to replace the BER in the message becomes the payload of the UDP message.

The respective operation is outlined in the step indicated by reference numeral 120 in FIGS. 15 and 18. This step preceeds the transmission step 122 destined to the respective dedicated port (called port X in general) of the receiver.

Also in this case, the complementary operation consists of three steps indicated by references 222 (reception via port Y of the module which is receiving at the time), 220 (PDU UDP payload extraction) and 218 (creation of compressed data unit intended to be transferred to step 206 in the flow chart in part b of FIG. 13).

Also in this case, steps 222, 220 and 218 are performed in the order in which they are shown.

The synchronisation message to which reference was made in the description above is sent by the manager A to the hierarchic agent AG according to a general application-to-application criteria using standard SNMP format containing a proprietor variable binding.

Transferred data types are:

| OID | Value |
|---|---|
| 1.3.6.1.4.666.2 | <UDP_TX_Port> |
| 1.3.6.1.4.666.3 | <UDP_RX_Port> |

Manager A sends a proprietor message to hierarchic agent AG compiling <UDP_TX_Port> with the number of the port intended to be used for UDP transmission (e.g. 1024) and <UDP_RX_Port> with the number of the port used for UDP reception (e.g. 1224). The hierarchic agent AG replies to manager A by sending a similar message containing its own information. This method reduces processing time by improving solution efficiency.

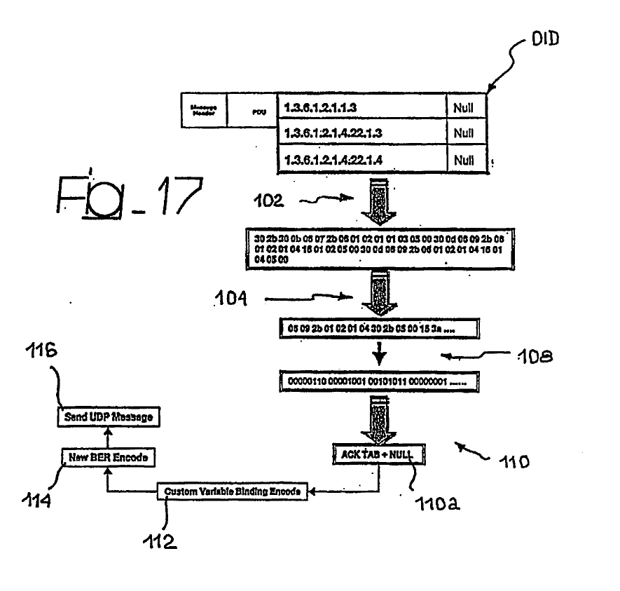

The flow chart in FIG. 16 additionally shows how the described solution may be generalised and applied to any type of message employing UDP for transport (e.g. SNMP, PING, etc.). This generalisation can be exploited to create a UDP driver capable of replacing those currently in use.

This solution consists in evaluating the size of the payload to be transferred and proceeding with the described method if the size is suitable (e.g. greater than 20 bytes). The 8 bits from bit 62 to bit 69 of the UDP message header can be used to state the compact nature of the UDP message, e.g. by setting one of the bits to 1 (this bits are currently not used and set to 0 by default).

Specifically, reference 300 in the diagram in FIG. 16 indicates any step in which the need to send a message susceptible of being transported in a UDP message is generated followed by a step 302 in which the payload is compressed according to the method described above.

A subsequent step 304 consists in generating the UDP message header in the terms mentioned above. A subsequent step indicated by reference 306 corresponds to the creation of the complete UDP message to prepare for IP transmission (implemented in step 308).

Naturally, numerous changes can be implemented to the construction and embodiments of the invention herein envisaged without departing from the scope of the present invention, as defined by the following claims.

1. A method managing a management activity of at least one managed object (b1, . . . , BN) by at least one manager object through a communication network (R), characterized in that it comprises the following steps:
providing at least one intermediate object (AG) configured to manage said at least one managed object (B1, . . . , BN) according to a data set (1102), said management activity being transformed into a set of results (1112),
providing said data set (1100) from said at least one manager object (A) to said intermediate object (AG),
managing said at least one managed object (B1, . . . , Bn) through said at least one intermediate object (AG), to generate said set of results, and
transferring (1108) said set of results from said at least one intermediate object (AG) to said at least one manager object (A).

2. The method according to claim 1 which comprises the step of establishing the communication between said at least one manager object (A) and said at least one intermediate object via UDP protocol.

3. The method according to claim 2 which comprises the following steps:
managing at least one further managed object (Bk. 25 BN) directly through said at least one manager object (M, and
managing said at least one managed object (B1, B2, B3) by said at least one manager object (A) via said intermediate object (AG).

4. The method according to claim 3 comprises the management of said at least one further managed object (Bk, . . . , Bn) and said at least one managed object (B1, B2, B3) through a single communication network (R).

5. The method according to claim 3 which comprises the following steps:
providing a first communication network (RP) for managing said at least one further managed object (B1) directly through said at least one manager object (A) and transferring said data set (1100) and said results set (1118) between said at least one manager object (A) and said at least one further managed object (B1), and
providing a second communication network (RA) for managing said at least one managed object (B2, B3) through said intermediate object (AG).

6. The method according to claim 3 which comprises the steps of providing a plurality of said intermediate objects (AG1, AG2) and managing at least one managed object (B3) through several intermediate objects (AG1, AG2) of said plurality.

7. The method according to claim 3 wherein said intermediate object (AG) is provided with respective reception modules (AU) and transmission modules (ATX) configured so that said at least one manager object (A) sees said intermediate object (AG) essentially as one of said managed objects (B1, . . . , Bn).

8. The method according to claim 3 wherein said at least one intermediate object (AG) comprises at least one respective management module (MM) configured so that said at least one managed object (B1, . . . , BN), which is managed by said at least one intermediate object (AG), sees said at least one intermediate object (AG) essentially as said at least one manager object (A).

9. The method according to an claim 3 wherein said at least one intermediate object (AG) is provided with one of the following queues:
an input queue (i) for collecting input messages with respect to said at least one intermediate object (AG),
an output queue (U) for collecting output messages from said at least one intermediate object (AG), and
a working queue (L) for collecting messages inherent to said management activity performed by said at least one intermediate object (AG) on said at least one managed object (B1,Bn).

10. The method according to claim 9 which comprises the step of providing, in said at least one intermediate object (AG), a dedicated module (DC) for analyzing the input messages received by said input queue (I).

11. The method according to claim 10 which comprises the following steps:
providing, in said at least one intermediate object (AG), an activity co-ordinating module (CA) for implementing at least one of the following functions:
instanctiating at least one concurrent process,
updating activity status of the requests in said working queue L, and
creating statistic check messages to be sent to said at least one manager object (A) through said output queue (U).

12. The method according to claim 9 which comprises the step of providing a plurality of protocol management modules (MP1, MP2, MP3) configured to establish communication to said at least one managed object (B1, BN) through respective different protocols in said at least one intermediate object (AG).

13. The method according to claim 9 which comprises the step of establishing the communication between said at least one manager object (A) and said at least one intermediate object (AG) by subjecting at least one part of the respective messages to a compression operation (302; 104, 204).

14. The method according to claim 13 wherein said compression operation is based on the acknowledgment of a sequence which appears periodically in the message.

15. The method according to claim 14 wherein said compression operation implements a gzip type method, such as zLib.

16. The method according to claim 2 which comprises the step of indicating that compression of the message transferred by UDP is done.

17. The method according to claim 16 wherein a bit field in the UDP header is used to indicate that the compression operation (302) is done.

18. The method according to claim 17 wherein bits comprised in the range from bit 62 to bit 69 in the UDP header are used in indicate that the compression operation (302) is done.

19. The method according to claim 18 which comprises the step of setting at least one of the bits from 62 to 69 of the UDP message header to 1.

20. The method according to claim 13 wherein the communication between said at least one manager object (A) and said at least one intermediate object (AG) is implemented by means of SNMP messages, and comprises the following steps during the compression step:
reading (100) the entire SNMP message,
encoding (102) the read message in hexadecimal 30 format, and
subjecting the message encoded in hexadecimal format to compression (104).

21. The method according to claim 13 wherein communication between said at least one manager object (A) and said at least one intermediate object (AG) is implemented by means of SNMP messages, comprises the following steps during the reception step:
subjecting the received message to decompression (204) a complementary to said compression operation, to obtain a message subjected to decoding in hexadecimal format,
decoding (202) the message from the hexadecimal 10 format, and
reconstructing (200) the entire SNMP message from said decoded message.

22. The method according to claim 21 which comprises a nesting operation in a standard SNMP message for the transmission of the message subjected to said compression operation (104).

23. The method according to claim 22 which comprises the following steps during transmission:
reading (108) the message subjected to said compression operation (104) in bytes and transposing (110) it into a corresponding ASCII character message,
generating (112) a variable binding set comprising a first OID indicating the original file size and subsequent OID/value pairs which carry portions of said message subjected to said compression operation (104) transposed into ASCII characters,
reconstructing SNMP message header data,
encoding (114) the resulting SNMP message in hexadecimal format to generate the UDP payload, and transferring (116) the UDP payload generated in this way.

24. The method according to claim 23 which comprises the following steps during reception:
receiving the message subjected to said compression operation as an UDP payload (216),
subjecting the payload received in this way to a hexadecimal decoding operation (214),
acknowledging and assembling (212) the variable binding of the message subjected to hexadecimal decoding,
subjecting the message subjected to said acknowledging 11 and assembling operation (212) to binary ASCII decoding (210), and
subjecting the decoded message in binary form to said decompression operation (204).

25. The method according to claim 21 which comprises the step of integrating the message subjected to said compression operation (104) through UDP nesting for the transmission of the message subjected to said compression operation (104).

26. The method according to claim 25 which comprises the following steps during transmission:
configuring said message subjected to said compression operation (104) as a Protocol Data Unit (PDU) payload, and
transferring the payload created in this way to a given receiver port.

27. The method according to claim 26 which comprises the following steps during reception:
receiving said message as a payload of a PDU UDP received at a receiver port, and
extracting said payload from said PDU.

28. The method according to claim 27 which comprises the step of transmitting a synchronisation message (1106) of the SNMP type indicating said transmission port and/or said reception port between said at least one manager object (A) and said at least one intermediate object (AG).

29. A system for managing communication networks comprising at least one manager object (A) and at least one managed object (B1, Bn), which comprises at least one intermediate object (AG) implementing the method according to claim 3.

30. A software module which can be directly loaded into the internal memory of at least a computer and comprising portions of software code to implement the method according to claim 3 when the software modules are run by at least one computer.
